(19) United States
(12) Patent Application Publication
(10) Pub. No.: US 2005/0035613 A1
(43) Pub. Date: Feb. 17, 2005

(54) Placing device and method for placing objects onto substrates

(76) Inventor: Rainer Duebel, Baldham (DE)

Correspondence Address: HARNESS, DICKEY & PIERCE, P.L.C., P.O.BOX 8910, RESTON, VA, 20195, US

(21) Appl. No.: 10/481,625

(22) PCT Filed: Jun. 12, 2002
(86) PCT No.: PCT/DE02/02152

(30) Foreign Application Priority Data
Jun. 19, 2001 (DE) 101 29 352.6

(51) Int. Cl. B66C 1/04

(52) U.S. Cl. 294/65.5

(57) ABSTRACT

A placing device and a method for placing objects onto substrates are suited for obtaining both very small as well as very large placement forces of the object exerted on the substrate. To this end, a gripper, by way of which the object can be picked up, is pretensioned with regard to a holder in a direction of placement. The pretensioning ensues via a first coupling element provided on the holder and via a second coupling element provided on the gripper. An electrical and/or magnetic field is generated between the first and the second coupling element and effects an action of force between the holder and the gripper. This enables a predetermined placement force to be attained when using the gripper to place the object.

This application is the national phase under 35 U.S.C. § 371 of PCT International Application No. PCT/DE02/02152 which has an International filing date of Jun. 12, 2002, which designated the United States of America and which claims priority on German Patent Application number DE 101 29 352.6 filed Jun. 19, 2001, the entire contents of which are hereby incorporated herein by reference.

### FIELD OF THE INVENTION

The invention generally relates to a placing device and a method for placing objects onto substrates. Preferably, it relates to one with a gripper being moveably arranged on a holder, which for placing the object on the substrates can be moved to the substrates. Between the gripper and holder a spiral spring is preferably arranged in such a way that during the placing of the gripper it is moved relative to the holder against the force of the spring. By this, a predetermined force as a placing force of the objects may be exerted on the substrates.

### BACKGROUND OF THE INVENTION

A known placing device, however, has a disadvantage that a variable force control of the placing force is possible only by determining that force with which the holder moves to the substrate. However, conventional drives for holders of this kind, and also the holders, have a large mass and therefore a large mass moment of inertia. The placing therefore does not take place at the placing force preset by the spring but instead by a considerably higher force that is exerted on the object and therefore also on the substrate. In addition to the mass moment of inertia of the holder, of the gripper and of the drive of the holder, the moment of inertia of the drive of the holder also has a negative effect in this case.

Particularly when fitting electrical components on substrates, it is necessary to have available low placing forces for placing the components on the substrates with high accuracy. This is not possible with conventional devices or with a conventional method.

### SUMMARY OF THE INVENTION

An object of an embodiment of the invention is therefore to provide a placing device and a method for placing objects onto substrates by which very small placing forces can be attained at high accuracy.

The object may be achieved by a placing device and/or by a placing method.

By use of a placing device in accordance with an embodiment of the invention, it is possible to achieve a controlled dynamic effect between a holder and a gripper moving relative to the holder by use of an electrical, magnetic and/or electromagnetic field. By controlling the field it is possible to predetermine the force very accurately. The predetermined placing force is in this case also independent of the distance covered by the gripper relative to the holder when placing the objects onto the substrates.

The controllable dynamic effect enables the placing force to be largely independent of the inertia effects of the placing device. During placing, only the moment of inertia of the gripper acts on the placing force. The moment of inertia of the holder and of the remaining placing device does not act on the placing force.

Different embodiments of the invention are shown. In one case, it is possible to use electromagnets and/or permanent magnets as coupling elements that interact with each other to generate a dynamic force by way of a field between the gripper and holder of a placing device. At least one of the coupling elements in accordance with an embodiment of the invention is in this case an electromagnet, for example a coil through which electric current flows. By controlling current flowing through the coil, the placing force of the object onto the substrate can be directly controlled.

If the relevant coupling element at the gripper is designed as an electromagnet, it is also possible to attain an even lower mass of the gripper. This effectively prevents peaks in the placing force.

By this, it is also possible to control the force pattern not only statically but also dynamically corresponding to a required and predetermined force pattern.

Furthermore, a damping element can be positioned in each case between a guiding device of the gripper that guides the gripper on the holder and between stop pieces provided on the holder. Thus, for example, before placing an object on a substrate this enables the gripper to be pretensioned against one of the damping elements by way of both coupling elements in such a way that the placing force or pattern of the placing force is determined only by the characteristic of the damping element.

With the method for placing a gripper on objects on a substrate in accordance with an embodiment of the invention, the pattern of the placing force during the placing of the object on the substrate can be determined in advance with regard to both the static and dynamic time characteristics of the placing force. By controlling the magnetic and/or electrical fields, by which the dynamic effect between the holder and gripper that determines the placing force is attained, variable placing forces are possible over a large force range.

By the method in accordance with an embodiment of the invention, it is possible both when placing objects on substrates to achieve predetermined placing forces, and also when lifting objects from substrates to effectively reduce acceleration peaks that act on the object. For this purpose, the gripper is moved to the holder before lifting objects from the substrates. In this position, the complete holder together with the gripper is lowered onto the object on the substrate and the object is lifted from the substrate by means of the gripper. During lifting, the gripper is moved against the direction of lift relative to the holder. This reduces the acceleration when lifting the object from the substrate.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 A schematic view of the placing device in accordance with an embodiment of the invention, with a gripper placed against a stop piece in a first pretensioned position.

FIG. 2 A schematic view of the placing device in accordance with an embodiment of the invention, with a gripper in an intermediate position.

FIG. 3 A schematic view of the placing device in accordance with an embodiment of the invention, with a gripper placed against another stop piece in a second pretensioned position.

### DETAILED DESCRIPTION OF THE PREFERRED EMBODIMENTS

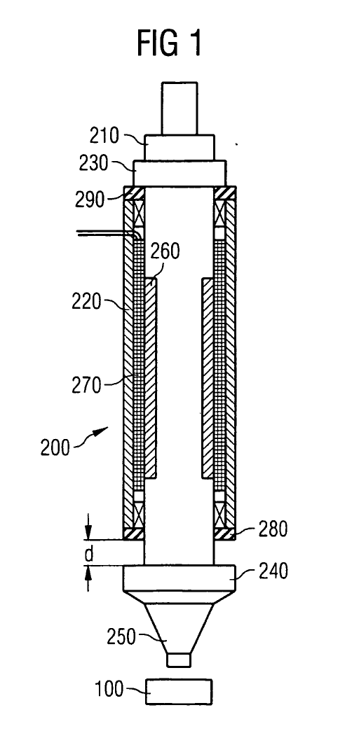

As can be seen from FIG. 1, the placing device 200 in accordance with the invention has a holder 220 and a gripper 241 that moves along the holder in a placing direction A. A vacuum pipette 250, for example, is fitted to the gripper 210 to hold objects 100. The gripper 210 is mounted on the holder 200 in such a way that the gripper 210 projects from the holder 220 in the placing direction A.

Two stop pieces 230 and 240 are arranged on the gripper 210. This gripper 210 is mounted in the placing direction A between both stop pieces 230 and 240 so that it can move linearly relative to the holder 220. The proximal stop piece 230 is in this case mounted on the gripper 210 facing away from the vacuum pipette 250. The distal stop piece 240 is mounted on the gripper 210 facing towards the vacuum pipette 250.

Resilient damping elements 290 and 290 can be mounted on the holder 220, facing towards the proximal stop piece 230 and distal stop piece 240 respectively.

The stop pieces 230 and 240 can also be formed on the holder 220, with the damping elements 290 or 280 being formed accordingly on the gripper. The complete range of movement of the gripper 210 relative to the holder 220 is equal to length d in the placing direction A.

The gripper 210 has a permanent magnet as a first coupling element 260 aligned in the placing direction A. An electromagnet 270 as a second coupling element, for example in the form of a coil or linear motor, is provided on the holder 220 and interacts with the permanent magnet 260 on the gripper 210. The gripper 210 is mounted on the holder 220 so that it is guided in the placing direction A by means of a guiding device (not illustrated).

FIG. 1 shows the placing device in accordance with an embodiment of the invention in a first pretensioned position. In this case, the gripper 210 is pretensioned in the placing direction toward the object 100 to be placed, relative to the holder 220, so that the proximal stop piece 230 lies against the holder 220 or against the proximal damping element 290. By presetting the current flowing through the coil or linear motor 270, it is possible to predetermine the force with which the gripper 210 is pretensioned relative to the holder 220 in the placing device A.

For placing, the placing device 200 in accordance with an embodiment of the invention is moved onto the object 100 by way of a drive that drives the holder 220 (not illustrated). When the object 100 is reached and the gripper 210 or vacuum pipette 250 is placed on the object 100 or the object 100 is placed on the substrate, while the holder 220 is moved onto the object 100 by use of the drive (not illustrated), the gripper 210 is moved relative to the holder against the placing direction A, so that the placing force predetermined by the current acts on the object 100. The mass moment of inertia occurring during this depends only on the mass of the gripper 210. The length of the movement range d, shown in FIG. 1, is thus reduced to d1<d at the distal end of the holder, with the distance d2 between the proximal stop piece 230 and holder 220 being correspondingly increased at the same time.

Thus, it is possible in accordance with the invention to preset very low placing forces with very high accuracy by pretensioning the gripper 210 in the placing direction relative to the holder 220. Furthermore, the required variable force patterns when placing can be achieved, in that the current that determines the force coupling between the gripper 210 and holder 220 is controlled corresponding to the required force pattern.

If the current setting is constant, the dynamic effect is essentially constant over the complete range of movement d of the gripper 210 relative to the holder 220. Thus, for example, a constant force is then exerted on the object if the substrate on which the object 100 is being place is moved in the placing direction A and/or oscillates. This enables the placing accuracy and reliability during placing to be easily increased.

FIG. 3 shows a placing device 200 in accordance with an embodiment of the invention in a second pretensioned position, in which the gripper 210 is completely spring-loaded against the placing direction A, i.e. the distal stop piece 240 is placed against the distal end area of the holder 200 or against the distal damper 280 of the holder 220. In this case, the force acting on the object when the holder 220 is moved onto the object 100 is determined only by the drive force with which the holder 220 is moved onto the object 100. By predetermining the properties of the damping element 280, it is possible to influence the pattern of the placing force in this operating mode.

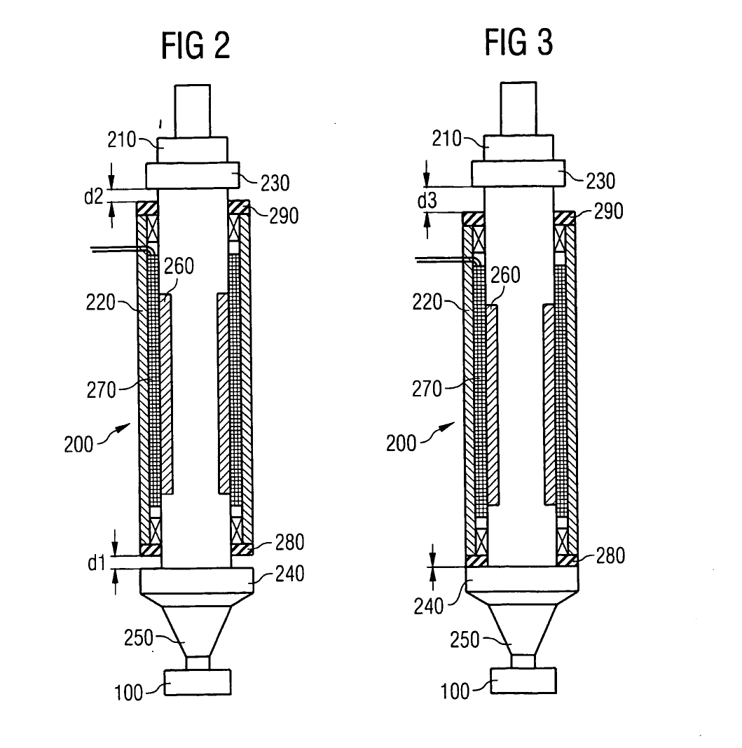

This can, however, cause very high placing forces to be achieved that cannot be achieved using the method already explained using FIGS. 1 and 2. This is because the dynamic effect between the gripper 210 and holder 220, determined by the two coupling elements, means that setting forces are possible only up to a certain level. For example, by way of the operating mode explained using FIGS. 1 and 2, placing forces of between 0.1 and 2 N can be achieved with an example of the placing device in accordance with the invention. For higher placing forces above 2 N, placing forces of between 2 N and 50 N can be achieved by using the operating mode explained in accordance with FIG. 3.

For example, it is also possible to suitably change the current characteristic determining the placing force, appropriately after placing the gripper on the object or placing the object on the substrate. In this case any force patterns are possible when placing an object on a substrate. Furthermore, it is possible to provide a position measuring system on the holder 220 and/or on the gripper 210. This would, for example, enable a standstill of the gripper 210 relative to the holder to be detected very quickly and a signal to be output that can signal the ending of the placing operation after the standstill.

It is also possible to measure the placing force of the gripper 210 by use of a force sensor before placing the object. The current values for the electric coil determined during use or predetermined, or the forces determined for the linear motor 270, can, for example, be stored in the form of electronic data. By varying the current during the comparative measurement, the placing force predetermined on the basis of a current can be precisely determined in advance and stored.

1. Placing device for placing objects on substrates, comprising:
a moving holder;
a gripper having a linear guided movement in a placing direction between two ends of a range of movement on the holder, wherein the gripper is adapted to lift the objects and move the objects to a substrate by moving the holder, wherein with the holder includes
a first coupling element and the gripper includes
a second coupling element and wherein at least one of
an electrical and magnetic force is generated by at least one of an electrical and magnetic field acting between the first coupling element and second coupling element, such that the gripper is pretensioned in the placing direction against one of the ends of the range of movement.

2. Placing device in accordance with claim 1, wherein
the first coupling element includes a coil through which an electric current flows,
the second coupling element includes a permanent magnet and
the placing force acting on the substrate when the object is being placed is controlled by controlling the strength of the current.

3. Placing device in accordance with claim 1, wherein
the first coupling element includes a permanent magnet,
the second coupling element includes a coil through which an electric current flows and
the placing force acting on the substrate when the object is being placed is controlled by controlling the strength of the current.

4. Placing device in accordance with claim 1, wherein
the first coupling element includes a first coil through which a first current flows,
the second coupling element includes a second coil through which a second current flows and
the placing force acting on the substrate when the object is being placed is controlled by controlling at least one of the strength of the current and the strength of the second current.

5. Placing device in accordance with claims 2, wherein
the first coupling element and the second coupling element form a linear motor.

6. Placing device in accordance with claims 1, wherein
the holder and the gripper are arranged coaxially relative to each other in the placing direction.

7. Placing device in accordance with claim 1, wherein
a stop piece is fitted at each end of the range of movement, so that the gripper is provided with a guided movement between the stop pieces on the holder by way of a guiding device.

8. Placing device in accordance with claim 7, wherein
a damping element is arranged at least one of at each stop piece and at each end area of the guiding device between the stop piece and the guiding device.

9. Placing device in accordance with claim 1, wherein
each coupling element is designed in the form of a hollow cylinder.

10. Method for placing objects on substrates using a gripper and a holder moving in a placing device, comprising:
linearly guiding the gripper on the holder in the placing direction using a guiding device between two ends of a range of movement, wherein the gripper projects from the holder in the placing direction; and
pretensioning the gripper against one of the two ends of the range of movement, whereby a predetermined placing force is specified that acts on the gripper when placing the object, wherein control of the
pretension of the gripper relative to the holder is effected by at least one of a controlled magnetic and an electrical field, and
wherein the magnitude of the pretension is set corresponding to a preset value by controlling the at least one magnetic and electrical field;
moving the holder in the placing direction onto at least one of the object and substrate for placing the gripper; and
exerting a predetermined placing force, from the gripper, on the object when being placed on the at least one of the object and the substrate, while the gripper is moved against the placing direction relative to the holder until the holder is stopped.

11. Method in accordance with claim 10, wherein
the controlled at least one of magnetic and electrical field is generated by coupling elements mounted on the holder and gripper, wherein
at least one of permanent magnets and coils through which currents flow are used as coupling elements and wherein
a coil through which current flows is used as at least one of the coupling elements.

12. Method in accordance with claims 10, wherein
the placing force is selectively predetermined relative to the properties of the object.

13. Method in accordance with claim 12, wherein
the guiding device of the gripper is placed against a stop piece formed at the proximal end of the range of movement before the placing on the object and wherein
the placing force of the gripper on the object is being predetermined, in that the application is carried out using a force corresponding to the required placing force.

14. Method in accordance with claim 12, wherein
the guiding device of the gripper is placed against a stop piece formed on the holder at the distal end of the range of movement before the placing of the object and wherein
the placing force with which the holder is moved onto the object is specified by predetermining the drive force.

15. Method for lifting the objects from substrates by use of a gripper, wherein the gripper includes a linearly guided movement in a lifting direction on a holder by way of a guiding device between the two ends of a range of movement, and wherein the gripper projects from the holder against the lifting direction, the method comprising:
moving the gripper to the distal end of the range of movement relative to the holder before lifting;
a moving the holder from the substrate in the lifting direction to lift the object from the substrates;
moving the gripper to the proximal end of the range of movement relative to the holder when lifting, with the
acceleration occurring on the object equalized.

16. Placing device for placing objects on substrates, comprising:
gripping means, movable in a placing direction among a range of movement on a holder, for moving the objects to a substrate in conjunction with the holder, wherein with the holder includes a first coupling element and the gripper includes a second coupling element; and
means for generating at least one of an electrical and magnetic force by at least one of an electrical and magnetic field acting between the first coupling element and second coupling element, so as to pretension the gripper in a direction against an end of the range of movement.

17. Placing device in accordance with claim 16, wherein the first coupling element includes a coil through which an electric current flows, the second coupling element includes a permanent magnet and a force acting on the substrate when the object is being placed is controlled by controlling the strength of the current.

18. Placing device in accordance with claim 16, wherein the first coupling element includes a permanent magnet, the second coupling element includes a coil through which an electric current flows and a force acting on the substrate when the object is being placed is controlled by controlling the strength of the current.

19. Placing device in accordance with claim 16, wherein the first coupling element includes a first coil through which a first current flows, the second coupling element includes a second coil through which a second current flows and a force acting on the substrate when the object is being placed is controlled by controlling at least one of the strength of the current and the strength of the second current.

20. Placing device for placing objects on substrates, comprising:
gripping means, movable in a placing direction among a range of movement on a holder, for moving the objects to a substrate in conjunction with the holder, wherein with the holder includes a first coupling element and the gripper includes a second coupling element; and
means for pretensioning the gripper in a direction against an end of the range of movement, the means including at least one of an electrical and magnetic force acting between the first coupling element and second coupling element.

21. Placing device in accordance with claim 20, wherein the first coupling element includes a coil through which an electric current flows, the second coupling element includes a permanent magnet and a force acting on the substrate when the object is being placed is controlled by controlling the strength of the current.

22. Placing device in accordance with claim 20, wherein the first coupling element includes a permanent magnet, the second coupling element includes a coil through which an electric current flows and a force acting on the substrate when the object is being placed is controlled by controlling the strength of the current.

23. Placing device in accordance with claim 20, wherein the first coupling element includes a first coil through which a first current flows, the second coupling element includes a second coil through which a second current flows and a force acting on the substrate when the object is being placed is controlled by controlling at least one of the strength of the current and the strength of the second current.

24. Placing device in accordance with claim 3, wherein the first coupling element and the second coupling element form a linear motor.

25. Placing device in accordance with claim 4, wherein the first coupling element and the second coupling element form a linear motor.

26. Method in accordance with claim 11, wherein the placing force is selectively predetermined relative to the properties of the object.

27. Method in accordance with claim 26, wherein the guiding device of the gripper is placed against a stop piece formed at the proximal end of the range of movement before the placing on the object and wherein the placing force of the gripper on the object is predetermined, in that the application is carried out using a force corresponding to the required placing force.

28. Method in accordance with claim 26, wherein the guiding device of the gripper is placed against a stop piece formed on the holder at the distal end of the range of movement before the placing of the object and wherein the placing force with which the holder is moved onto the object is specified by predetermining the drive force.
